(19) United States
(12) Patent Application Publication
(10) Pub. No.: US 2001/0037403 A1
(43) Pub. Date: Nov. 1, 2001

(54) Program license key issuing method and issuing system

(76) Inventors: Masao Mougi, Tokyo (JP); Hisao Honma, Tokyo (JP); Makoto Kogai, Tokyo (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/841,883

(22) Filed: Apr. 24, 2001

(30) Foreign Application Priority Data
Apr. 28, 2000 (JP) 2000-134234

(51) Int. Cl. G06F 15/16; G06F 15/173

(52) U.S. Cl. 709/238; 709/200

(57) ABSTRACT

In performing the issuance of a license key to a user through a selling agent or the like on line, the issuance of the license key is performed from a manufacturer to the selling agent or the like in such a manner that information which the selling agent or the like wants to keep in secret is prevented from being transmitted to the manufacturer. Further, when a deadline of a trial period by a trial license key is coming very close, a special license key which extends the deadline of the trial period is issued. In operation, the sales computer receives client information, a product number and a license program name inputted by a purchaser computer and transfers such information from which the client information is eliminated to the license-issuing computer. The license-issuing computer issues the license key when the authentication of the product number is normally finished. Further, the present invention provides a trial license key to a user. When the deadline of the trial period is coming very close so that the extension of the deadline is necessary, a special license key is issued by transmitting the trial license key or the like to the license-issuing computer.

### BACKGROUND OF THE INVENTION

1. Field of the Invention

The present invention relates to a method for issuing a license key to make various product programs operable through the Internet, and more particularly to a license issuing method which allows a selling agent to filter information when licensing is performed through a selling agent or the like.

2. Background of the Invention

Conventionally, a method for acquiring a license key by making use of a network, has been one in which a license key is acquired from a license provider. The licensed user is given, a personal ID, such as an identification number or the like. When the license is granted to a user terminal, a terminal ID such as an identification number of the terminal or the like is given. A person who wants to use a service can receive the service from a service provider by inputting a given password which was previously determined between the user and the service provider, for example, together with a user ID such as an identification number or a serial number ID which can identify each user individually. Communication means between the service side and the users is disclosed in Japanese Laid-open Patent Publication 335170/1996. A technique which has network nodes give utilization licenses for information offer services to the communication terminals connected to the network adapter nodes has been generally used.

It is often the case that a computer system such as a disc subsystem has an optional function which allows, upon payment of a use charge, the use of programs for the operating system in addition to the licensed programs for operating the system. This optional program is designed such that the producer of a system or the provider of a program provides a key which allows the use of the program which was previously installed in the system, or the producer of a system or the provider of a program offers the program itself. Further, for information equipment such as a computer system, it is often the case that a producer offers a system through a seller. In this case, a seller provides the program itself, or a program key to a memory medium on which the program or the program key is stored.

### SUMMARY OF THE INVENTION

In a system which allows a client to acquire a given license key from a license-issuing computer connected to a network, client information (for example, a purchased date, a user name, a user address, a product name or the like) is used to determine whether a license acquisition applicant is a purchase. However, today, when electronic commerce has been actively transacted and has become popular, the fact that license application processing will be performed across several enterprises must be considered. On the other hand, since user information is confidential information for the respective enterprises, it is necessary to develop a license issuing system which filters information, taking these issues into consideration in advance.

For example, for computer-related information equipment, a license which allows the use of an optional program stored in the information equipment sometimes issues through a seller who has sold the information equipment. In this case, a program license issuing person is also an agent of the manufacturer of the program and information equipment. Further, in a data storage system, to build up or to change the constitution of a SAN (Storage Area Network) or the like, it is necessary to promptly issue the license for the optional program.

In addition, a user can use such a system by acquiring program use rights from a program use rights grantor through the network. Accordingly, when such a system is used as the primary license key acquisition means, it is apparent that the license-issuing computer becomes an important infrastructure. However, the conventional license key issuing system has not given any consideration to a case in which it becomes impossible to access the license-issuing computer connected to the network because of equipment, program, or other failures.

Accordingly, it is necessary to ensure a plurality of access paths which prevent the failures from affecting the users even when the failures occur in the equipment.

Further, there has been a problem that confirming whether or not the person requesting issuance of the license is a purchaser at the time of issuing the license key has been performed only through the comparison of a password, a user ID, a serial number, or the like. This implies that it is difficult to confirm a counterpart in a face-to-face manner. Thus the possibility of wrongful use occurring is increased, corresponding to the increase of cost and attractiveness of a product. Accordingly, it is necessary to provide a mechanism which can enhance the security of confirming whether the counterpart with whom data is exchanged through the network is truly a purchaser and which can prove the authenticity of the content.

Further, as a distribution form of a program disclosed in Japanese Laid-Open Patent Publication 335170/1996, there is disclosed a technique which stores a program in a CD-ROM and inhibits the operation of software when a given period which corresponding to the duration of time that the program in the CD-ROM is used elapses. Considering users who want to use the program on a trial basis or users who do not want to use the program after a certain period, a mode which allows the use of the program for a limited time has generally been generally used. However, from the viewpoint of a user who actually uses the program to evaluate the software, the limited-use-period mode can suddenly prevent use of the program, ignoring the circumstances of the use; hence, the mode and the consideration of availability to this type of service user is not sufficient. That is, although the program acquired from the program provider has been used in general based on a right of use set for a fixed time, a license key which can extend the period free of charge has not heretofore been proposed.

Further, in an environment in which a client acquires a license key from an information storage licensing computer on a network, it has been difficult for the conventional license-issuing system to obtain a desired information license key from a client terminal when a malfunction occurs at a communication terminal or in service-offer-side license-issuing computer equipment or when a malfunction occurs at a portion of a path leading to the license-issuing computer which stores given information as seen from the user terminal.

It is an object of the present invention to provide a method and system to be used when a license key is issued by the licensor of a program to a user through a selling agent, or the like, online. The method and system allow the selling agent or the like to extract and conceal a portion of the information necessary for the issuance of a license key from the requisite information transmitted by the user at the time the request for issuance of license key is made, whereby the issuance of the license key can be promptly carried out by the licensor through the selling agent, or the like.

It is another object of the present invention to provide a method and a system in which a trial license key which allows a client to use a program for a given period is issued, and when the deadline of the trial period is about to come up during use of the trial license key, a special license key which extends the trial period can be issued. Further, even when failure of license-issuing computer equipment or failure of a circuit occurs by chance when the special license key is being issued, processing for issuing a special license key can be performed by a service-provider-side license-issuing computer via communication means, such as a facsimile machine, electronic mail, telephone or the like, with the service provider being on a route separate from the system.

Further, the trial period of a trial license key can be extended by using a special license key which is described in a product manual or on an electronic medium such as a CD-ROM, or the like, which is packaged together with a program at the time of shipping the program.

It is yet another object of the present invention to provide a method and system which minimizes the possibility that a service provider cannot recover the payment of a fair-paid license key depending on the degree of the extension of the period. Services which have differing durations depending on the order of trial periods set by the service provider, can be realized as new value-added services. More specifically, a means that can issue a license key having a high disc capacity to a short-term-period user is offered to a client as an added value from the standpoint of service.

To solve the above-mentioned tasks, the present invention provides a license issuing system which includes a license-issuing computer, a seller computer, a purchaser computer, and a network which connects the license-issuing computer, wherein the improvement is characterized by the following: the seller computer requests the inputting of client information, product information and license program information to the purchaser computer; the purchaser computer transfers the client information, the product information and the license program information to the seller computer; the seller computer transfers the product information and the license program information out of the client information; the remaining product information and license program information are sent from the purchaser computer to the license-issuing computer; and the license-issuing computer issues a license key for the program specified by the license program information to the purchaser computer through the seller computer upon normal completion of the authentication of the product information received from the seller computer.

Further, the present invention uses a client number to further ensure confirmation of whether or not the client is a genuine client so that the reliability of the confirmation is further enhanced. Here, the client number is a number which a service provider (a seller) allocates to a client without duplication when the client has purchased a product. Further, the product information is information by which the licensor identifies the product. In this invention, a product number can be used as the product information. The product number can be used even when the products are same products. Identification information including these product numbers and client numbers is initially registered in a file storage disc (disc) of the license-issuing computer as an authentication key and check operation to determine whether access is to be allowed. Authentication is carried out based on this data base (DB) information matching the inputted client number and product number.

Further, the present invention provides a trial license key which allows are user to use a product program on a trial basis. The user acquires the license key via the network.

Further, according to the present invention, when a user acquires a trial license key and uses the product program on a trial basis, a special license key which allows the extension of the period of the trial license key is issued to a user requesting extension of the period because of the immanent deadline of the trial period. Here, the user communicates the name of the license program and the trial license key as well as the product information, or the like, to the license-issuing computer through the seller computer. The license-issuing computer issues a special license key to the client through the seller computer when the information matches that of the trial license key information held by the license-issuing computer.

Further, a license-issuing computer failure or a circuit failure occurs when a user is about to receive a special license key, the user communicates the client information, the product information, the name of the license program and the trial license key to the license-issuing computer through the seller by using a route such as a facsimile, electronic mail, a telephone, or the like, which is separate from the system. The license-issuing computer issues the special license key to the client through the seller computer when user information matches the trial license key information held by the license-issuing computer.

Further, the special license key to extend the trial period can be provided, by describing the special license key in a product manual stored on an electronic medium such as a CD-ROM, or the like, which is packaged together with a disc subsystem device at the time of shipping such a subsystem device. In an emergency, extension of the period can be performed using the special license key.

Further, is designed such that in a case where the client is issued a paid license key, and the free trial period license key is for a short duration, the user can receive a license key having high functions or high values. A high-function, high-value license key is a license key having a high memory capacity which can be used on a trial basis when the license relates to a program of the data storage system, for example.

### BRIEF DESCRIPTION OF THE DRAWINGS

FIG. 1 is a schematic diagram of a system which performs a license key issuing method according to the present invention.

FIG. 2 is a flow chart of the license key issuing method based on a first embodiment of the present invention.

FIG. 3 is a schematic diagram of the first embodiment of the present invention.

FIG. 4 is a schematic diagram of a second embodiment of the present invention.

FIG. 5 is a schematic diagram of a third embodiment of the present invention.

FIG. 6 is a schematic diagram of a fourth embodiment of the present invention.

FIG. 7 is a schematic diagram of a fifth embodiment of the present invention.

FIG. 8 is a schematic diagram of a sixth embodiment of the present invention.

FIG. 9 is a block diagram showing a cost system table of a product program of the sixth embodiment of the present invention.

FIG. 10 is a block diagram showing the content of services of the sixth embodiment of the present invention.

### DESCRIPTION OF THE SPECIFIC EMBODIMENTS

Preferred embodiments of the present invention are explained in detail hereinafter in conjunction with attached drawings.

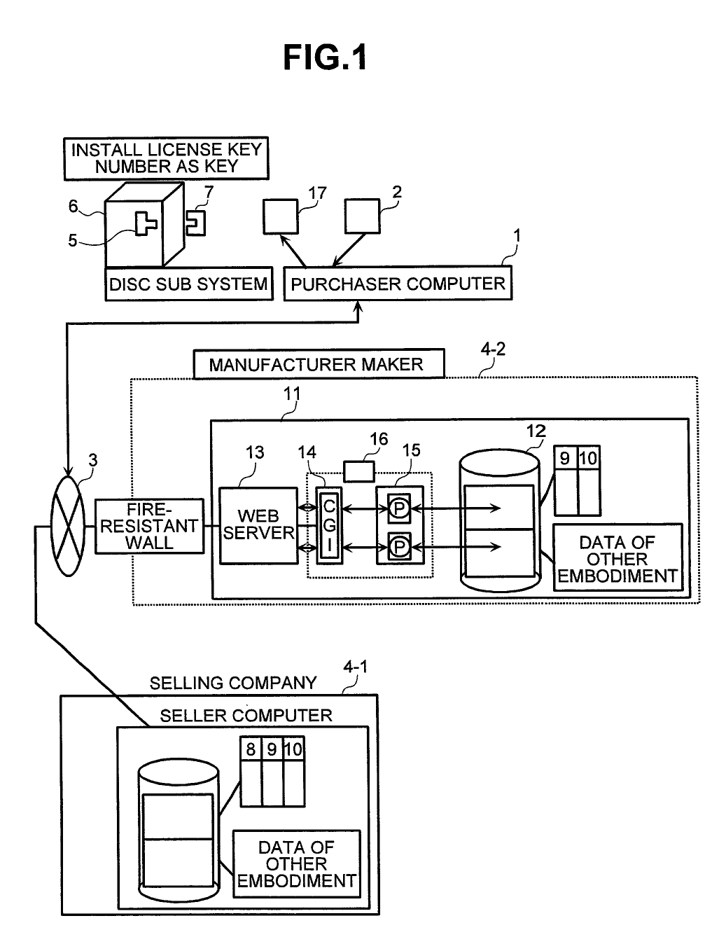

FIG. 1 is a schematic diagram showing the configuration of a system which performs a license issuing method according to the present invention. In this example, a program for operating a disc subsystem device is the object of a license. As a purchaser computer 1, either one of a PC (personal computer) and a work station which incorporates, for example, a display, a driver such as a keyboard, mouse, or the like; an OS (operating system); or a WWW (world wide web) browser is used, and purchaser computer 1 has a configuration which enables the connection thereof with the network. Using purchaser computer 1, users access to a home page provided by a license-issuing computer 11 or a seller computer. Purchaser computer 1 is connected to a selling company 4-1 and a manufacturer/licensor 4-2 through Internet 3; hence, selling company 4-1 and manufacturer 4-2 can identify purchaser computer 1.

The function of the product program for operating the disc subsystem device 6 shown in FIG. 1 is available to the user when the user inputs a key code 5. In the present invention, the issuance of the license key is performed through the network. Here, the flow of processing for acquiring the license key by making use of the system of this embodiment is explained.

First, to issue a license key 7 by making use of a network, there exists a method which designates a URL (Uniform Resource Locator, a site of a home page to be accessed) by use of a WWW browser. The URL for acquiring license key 7 is communicated to the client at the time disc subsystem device 6 is shipped. This URL usually belongs to the selling company. In an information data base (DB) of a license-issuing computer 11 of a manufacturer, a program is stored which performs the transfer of information between an information data base 12 and a seller computer and which issues a license key and information such as a product number 9, a license program name 10, and the like, while excluding client information 8. An access to WWW server 13 of license-issuing computer 11 can be performed through a WWW server of the seller company computer. When WWW server 13 receives the access, WWW server 13 starts a license-issuing program 15 through a CGI (Common Gateway Interface) 14 and transfers information transmitted from the seller computer to the license-issuing program 15.

Further, the seller computer stores information such as client information 8, product number 9, license program name 10, and the like; a program which allows the inputting of this information; and a program which transmits to license-issuing computer 11 information such as the product number 9, the license program name 10, and the like, while excluding the client information 8. The program which allows the inputting of the data may be stored in the DB 12 of the license-issuing computer 11. The program which allows the inputting of the data can be accessed from purchaser computer 1 and the data input to the purchaser computer is performed by the purchaser. The program which transmits information to the license-issuing computer transmits product number 9, license program name 10, and the like, to the license-issuing computer after eliminating the client information from the information received from the purchaser computer.

When the user accesses the seller computer from purchaser computer 1 via the WWW server, a message which requests the inputting of an encrypted number is shown on a display in the WWW browser of purchaser computer 1. When the user inputs the encrypted number, the seller computer compares the encrypted number to the number stored in database 12. When the encrypted number is correct, purchaser computer 1 transmits a start request to license-issuing computer 11. Thereafter, based on a program which allows the inputting of information such as client information 8, product number 9, license program name 10, or the like, of the seller computer, a message which requests the inputting of information such as client information 8, product number 9, license program name 10, or the like, is displayed on the WWW browser of, purchaser computer 1. When the user inputs client information 8, product number 9 and license program name 10 using an inputting screen, the information is transferred to the seller computer. The seller computer eliminates client information from client information 8, product number 9 and license program 10 and then transfers product number 9 and license program name 10 to the license-issuing computer.

Upon receiving the start request license-issuing computer 11 starts the licensing key issuing service. The license-issuing computer 11 determines whether the received product number 9 is valid data or not. When the product number is invalid, the license key issuing service is interrupted.

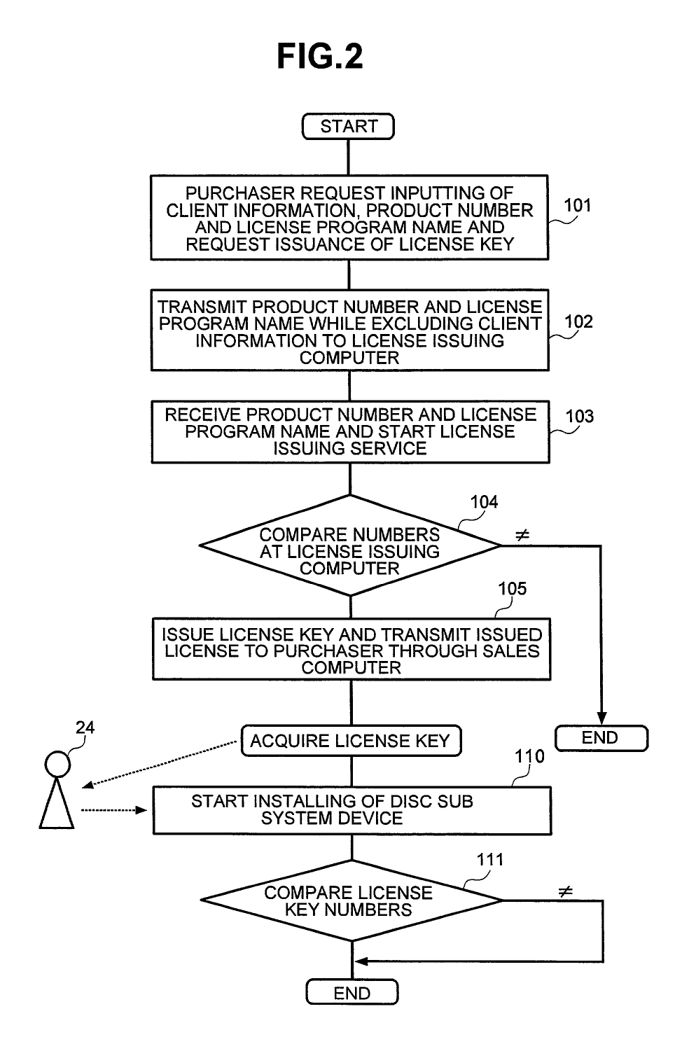

When the authentication of product number 9 is normally completed, the license key is issued by license-issuing computer 11 through the seller computer and is displayed on the WWW browser of purchaser computer 1. The user inputs this license key to the disc subsystem and compares the license key with a key code 5, which is already installed in a disc sub drive system device 6. If the license key and the key code 5 match, a desired operational product program can be installed in disc subsystem device 6. Subsequently, the process of a network system of the embodiment in which the program license key of the disc subsystem device is applied to an electronic commerce system is the same as that shown in the flow chart of FIG. 2 which illustrates the operation procedure, which will be explained later. However, they differ in the configuration of the license-issuing computer and the data processing procedure. In describing common configurations like parts are given like numbers.

Next, the manner of acquiring license key 7 shown in FIG. 1 is explained in conjunction with the flow chart of FIG. 2 showing the operational steps.

In step 101, the purchaser inputs client information 8, product number 9, and license program name 10 at the purchaser computer 1 and requests the seller computer to issue a license key.

In step 102, the seller computer eliminates client information 8 from the information transmitted by the purchaser computer and then transmits the information including product number 9 and license program number 10 to the license-issuing computer 11 of the manufacturer and requests issuance of a license key.

In step 103, license-issuing computer 11 receives the information including product number 9 and license program name 10 and starts the license-issuing program and the license issuing service.

In step 104, license-issuing computer 11 compares received product number 9 with the information already registered in information database (DB) 12. When comparison result is a match, license key 7 is issued in step 105 license key 7 is transmitted by purchaser computer 1 to the user 24 via the seller computer and user 24 can acquire the license key (step 106). If the data do not match, authentication fails, and the license issuing service ends.

User 24 installs the product program in disc subsystem device 6 using acquired license key 7 (step 110).

In step 111, authentication of license key 7 inputted at installation is performed and if license key 7 is not authenticated, the processing ends.

The preceding embodiment description specifically explains a system-side mechanism. Embodiments and applications of specific contents of services to clients are explained hereinafter.

### Embodiment 1

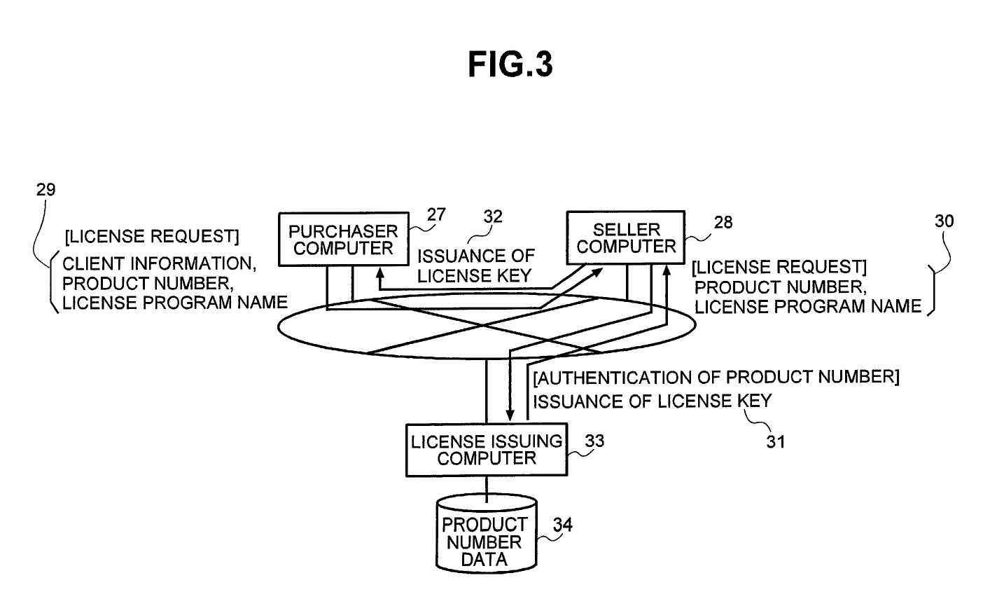

FIG. 3 is a diagram showing a license key issuing service to which a program license key electronic commerce system of the disc subsystem device of the first embodiment of the invention is applied. The configuration of the network system of this embodiment is identical to those of other embodiments which are explained later and differs from the configurations of these embodiments in the configuration of the license-issuing computer, the data processing procedure, and the like. The parts common to all embodiments are described using the same reference numbers.

The license-issuing system of this embodiment comprises a purchaser computer 27, a seller computer 28, a license-issuing computer, and a network to which respective computers are connected. In this license issuing system, a client acquires a license key which makes various product programs of a disc subsystem device operable from an information storage license-issuing computer 33 on a network using a product number. To acquire the license key to make the various product programs of the disc subsystem device operable, purchaser computer 27 transmits a license request containing client information and a license program name (29) as well as information including the product number, which identifies the purchaser to seller computer 28.

Subsequently, seller computer 28 transmits to license-issuing computer 33 the product number and the license program name (30) which constitute the license key issuing condition, from which the client information has been eliminated.

License-issuing computer 33 compares the product number transmitted from seller computer 28 with product number data 34 which the license-issuing computer 33 contains and which has already been shipped to the client, and locates the product number transmitted from the seller computer. When these product numbers are compared and found to match, a license key based on the desired license program name is transmitted to the seller server.

Thereafter, seller computer 28 issues a license key to purchaser computer 27.

### Embodiment 2

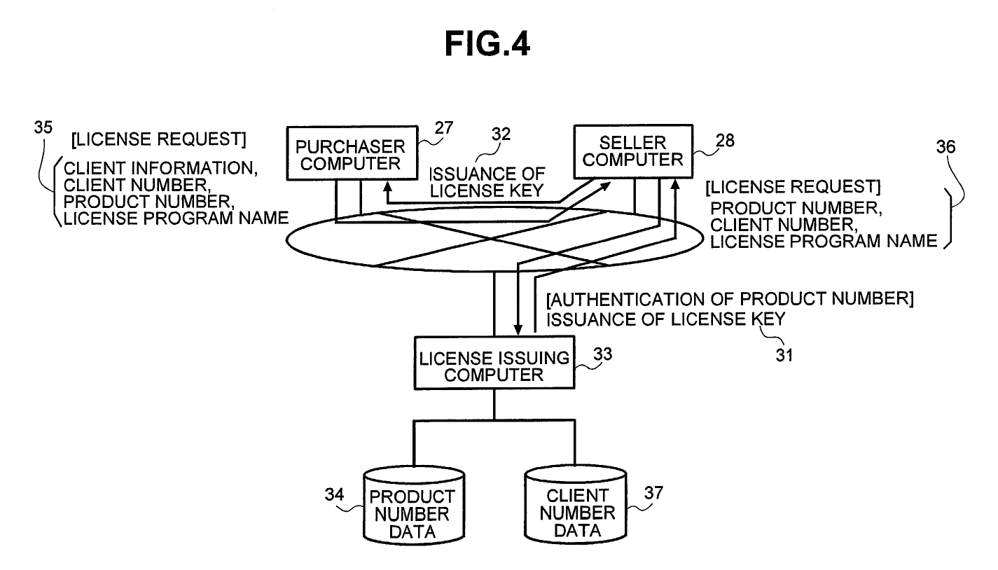

FIG. 4 shows a second embodiment of the license key issuing service according to the present invention. The second embodiment reinforces the purchaser authentication means compared to the first embodiment.

To receive a license key from a license-issuing computer 33 connected to a network, a user transmits to seller computer 28 client information and a license program name (35), as well as information including a product number and a client number for identifying the purchaser, all of which are necessary for acquiring a license key to make various product programs of a disc subsystem device operable.

Seller computer 28 eliminates the client information from the information transmitted by the user and transmits the product number, the client number and a license program name (36) which constitute the license key issuing condition to license-issuing computer 33.

License-issuing computer 33 contains data about product number 34 and client number 37 which have already been shipped. License-issuing computer 33 locates the product number and client numbers transmitted from seller computer 28. When these product and client numbers are respectively compared and found to match, a license key 31 based on the desired license program name is transmitted to seller computer 28.

Thereafter, seller computer 28 issues license key 32 to purchaser computer 27 through the network.

### Embodiment 3

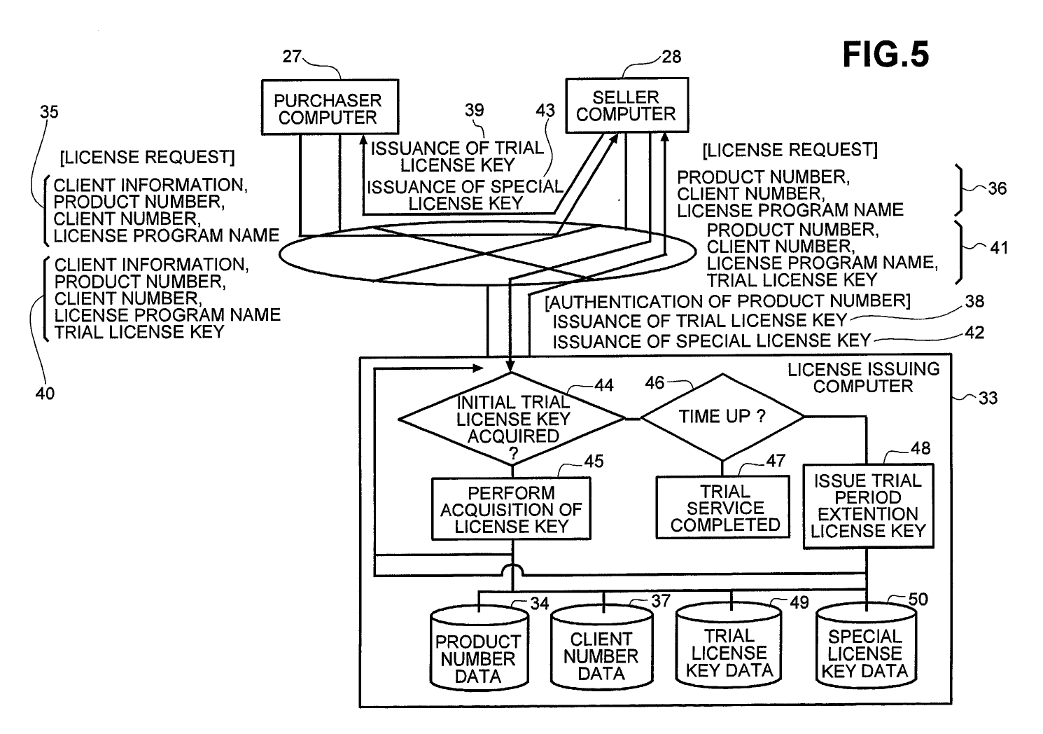

FIG. 5 is a diagram of a third embodiment of the license key issuing method of the present invention. The third embodiment issues a trial license key that allows a product program to be used on a trial basis. Further, when the deadline for a trial period is immanent and extension of the trial period is needed when it would otherwise be necessary to change from a free-of-charge license key to a paid license key, e issuance of a special license key for a one-time extension of the use deadline is carried out. To receive a license key from a license-issuing computer 33 connected to a network, using purchaser computer 27, a user transmits to seller computer 28 client information and a license program name (35), as well as information including a product number and a client number for identifying the purchaser, all which are necessary for acquiring a trial license key that makes a product program of a disc subsystem device operable for a licensed user.

Seller computer 28 eliminates client information transmitted from purchaser computer 27 and transmits the product number, the client number and a license program name (36), which constitute the trial license key issuing condition, to license-issuing computer 33.

License-issuing computer 33 contains data about product number 34 and client number 37 which have been already shipped to the client.. License-issuing computer 33 locates the product number and the client number. When the respective product and client numbers are compared and found to match a trial license key 38 based on the desired license program name is transmitted to seller computer 28. Thereafter, seller computer 28 issues a trial license key 39 to purchaser computer 27 through the network.

Further, when a deadline of a trial period is immanent and a purchaser requests an extension of the trial period, a special license key 43 extending the deadline of the trial period may be obtained from the license-issuing computer 33 through the seller, after the client information, the license program name and the trial license key (40) are transmitted to seller computer 28, along with information including the product number and the client number for identifying the purchaser.

Seller computer 28 eliminates the client information from the information transmitted from the purchaser computer 27 and transmits to license-issuing computer 33 the information necessary for issuing the special license key, including the product number, the client number and a trial key license program name (41).

License-issuing computer 33 contains information about trial license key 49 which has already been issued to the client. When the product number, the client number and the trial license key data transmitted from the seller computer 28 are compared with information held by the license-issuing computer 33 and found to match, the license-issuing computer 33 transmits a special license key 42 based on the transmitted license program name, for extending the trial period deadline. Seller computer 28 then issues a single-use special license key 43 to purchaser computer 27 through the network.

### Embodiment 4

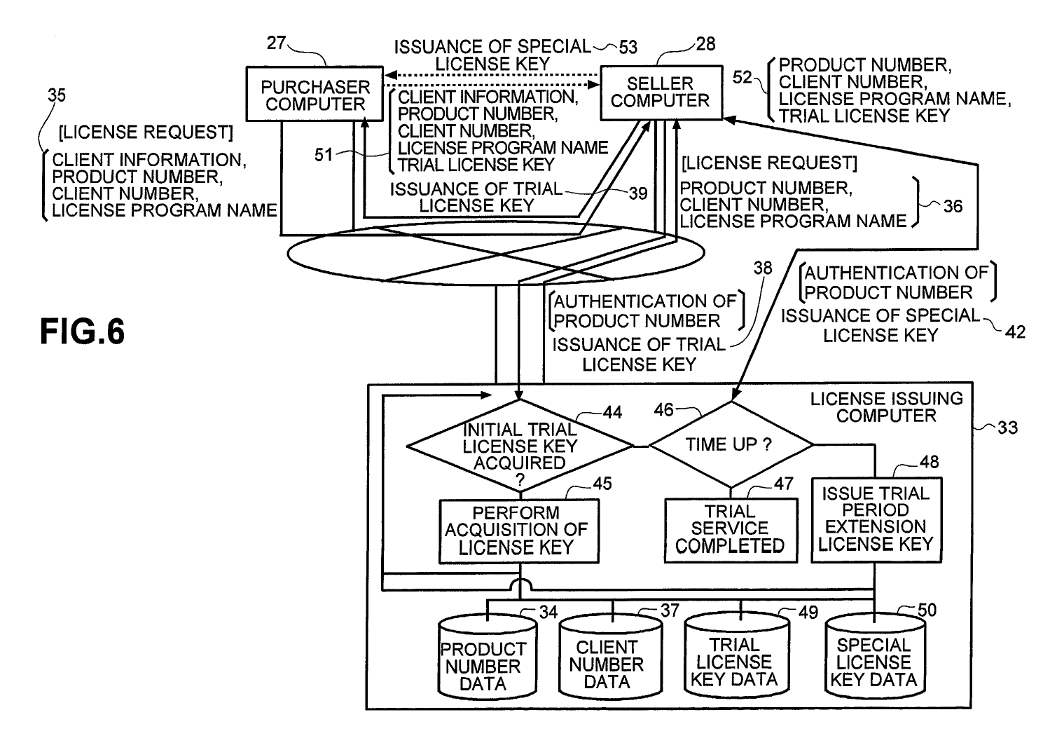

FIG. 6 is a schematic diagram of a fourth embodiment of the program license key issuing method according to the present invention. The fourth embodiment offers a service through which a product program thereof can be used on a trial basis, and, when a deadline of a trial period is immanent and extension of the deadline of the trial period is necessary, either a license key or a paid license key for extending the deadline can be issued from a route separate from the system.

Having received a license key from a license-issuing computer 33 connected to a network, a user who wishes to acquire a trial license key to make a product program of a disc subsystem device operable on a trial basis, transmits from purchaser computer 27 to seller computer 28 client information and a license program name (35) as well as information including a product number and a client number for identifying the purchaser.

Seller computer 28 eliminates client information from the information transmitted from the purchaser computer and transmits the information necessary for issuing the trial licensing key, including the product number, the client number and a license program name (36). to license-issuing computer 33.

License-issuing computer 33 contains data on product number 34 and client number 37 which have been already shipped to the client. License-issuing computer 33 locates 44 the product number and the client number transmitted from seller computer 28. When these product numbers and the client numbers are respectively, compared and found to match, a trial license key 38 based on the license program name transmitted from the sellers computer is transmitted to seller computer 28

Thereafter, seller computer 28 issues a trial license key 39 to purchaser computer 27 through the network.

Further, when a deadline of a trial period draws near during the trial and the purchaser changes from a trial license key to a paid license key, if a failure of the license-issuing computer 33 or a failure of a circuit occurs, as an alternate means to extend the deadline of the trial period, the user can obtain issuance of a special key for extending the deadline of trial period of the program using a route separate from the system, such as a facsimile, electronic mail, a telephone, or the like. In this case, the purchaser sends the client information, the name of the license program and the trial license key, as well as information including the product number which identifies the purchaser to the seller by using an alternate route..

Seller computer 28 has means to input the product number, the license program name, the trial license key and the like which are communicated from the purchaser. Here, the seller eliminates the client information from the information transmitted from the purchaser and sends license-issuing computer 33 the information necessary for issuing the special license key, including the product number, the license program name and the trial license key.

License-issuing computer 33 possesses data on a trial license key 49 which has been already shipped to the client. Then, the license-issuing computer 33 locates the product number and the trial license key transmitted from seller computer 28. When the product number and the trial license key transmitted from seller computer 28 are compared to information possessed by the license-issuing computer 33 and found to match, the license-issuing computer 33 transmits to seller computer 28 a special license key 53 based on the transmitted license program name to extend the deadline of the trial period.

Seller computer 28 has means to output the license key transmitted from the license-issuing computer. Here, the seller outputs the special license key transmitted from license-issuing computer 33 and transmits the special license key to the purchaser through a route separate from the system, such as a facsimile, electronic mail, a telephone, or the like.

### Embodiment 5

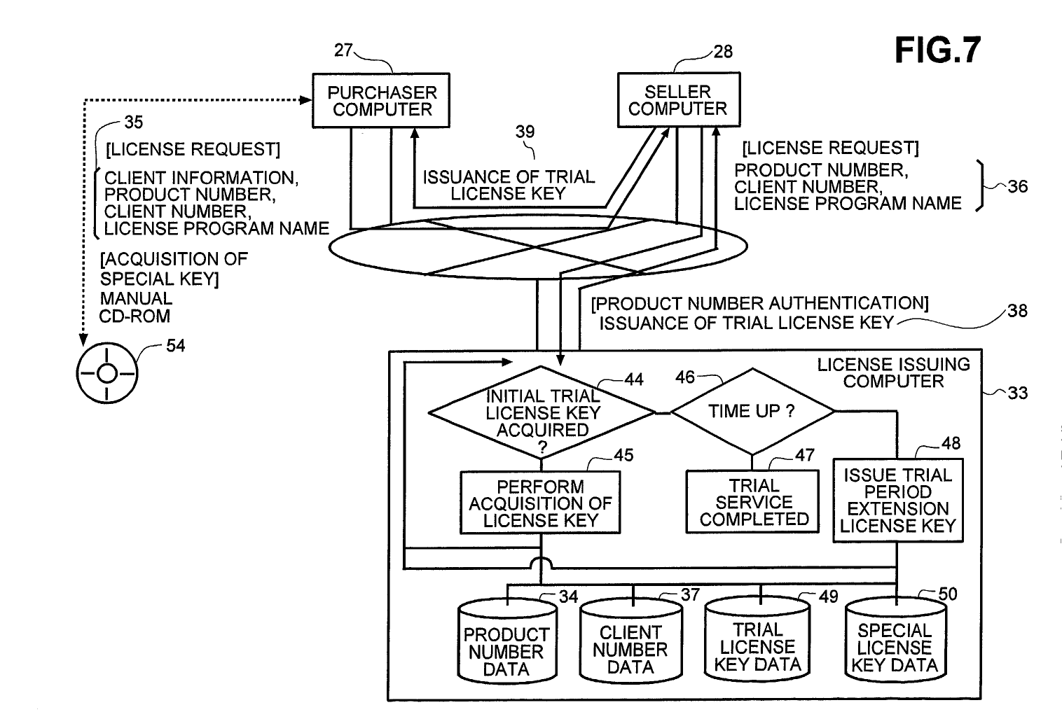

FIG. 7 shows a fifth embodiment of the program license key issuing method according to the present invention. The fifth embodiment provides a service whereby a user having a product program for use on a trial basis, with the trial period deadline drawing near, can obtain an extension of the deadline by using information described in a manual that was packaged together with a device.

To receive a license key from a license-issuing computer 33 connected to a network, a user transmits from purchaser computer 27 to seller 28 client information and a license program name (35) as well as information including a product number and a client number for identifying the purchaser which are necessary for acquiring the trial license key to make product programs of a disc subsystem device operable. Seller computer 28 eliminates the client information from the information transmitted from purchaser computer 27 and transmits to license-issuing computer 33 the product number and a license program name which are necessary for issuing the trial licensing key. License-issuing computer 33 possesses data on a product number 34 and the like, which have been shipped to the client. License-issuing computer 33 locates the product number transmitted from the seller computer 28. When the product numbers are compared and found to match, a trial license key based on the transmitted license program name 38 is transmitted to the seller computer 28. Thereafter, seller computer 28 issues trial license key 39 to purchaser computer 27 through the network.

Further, when a deadline of a trial period draws near during the trial and the purchaser changes from a trial license key 39 to a paid license key, if there is a failure of a license-issuing computer 33 or a failure of a circuit before the paid license key is issued, a special license key which allows the extension of the deadline of the trial period can be obtained by following the description in a manual or a CD-ROM packaged together with a product at the time the product was shipped. In this case, the trial period may be extended by using a special license key described in a product having a product number communicated by the client at the time the trial license key was issued.

According to the above-mentioned embodiments 3-5, when the deadline of a trial period is immanent during use of the product program on a trial basis, the trial period deadline can be extended without any interruption of operation, through the provision, prior to expiration of the trial period, of a special license key.

### Embodiment 6

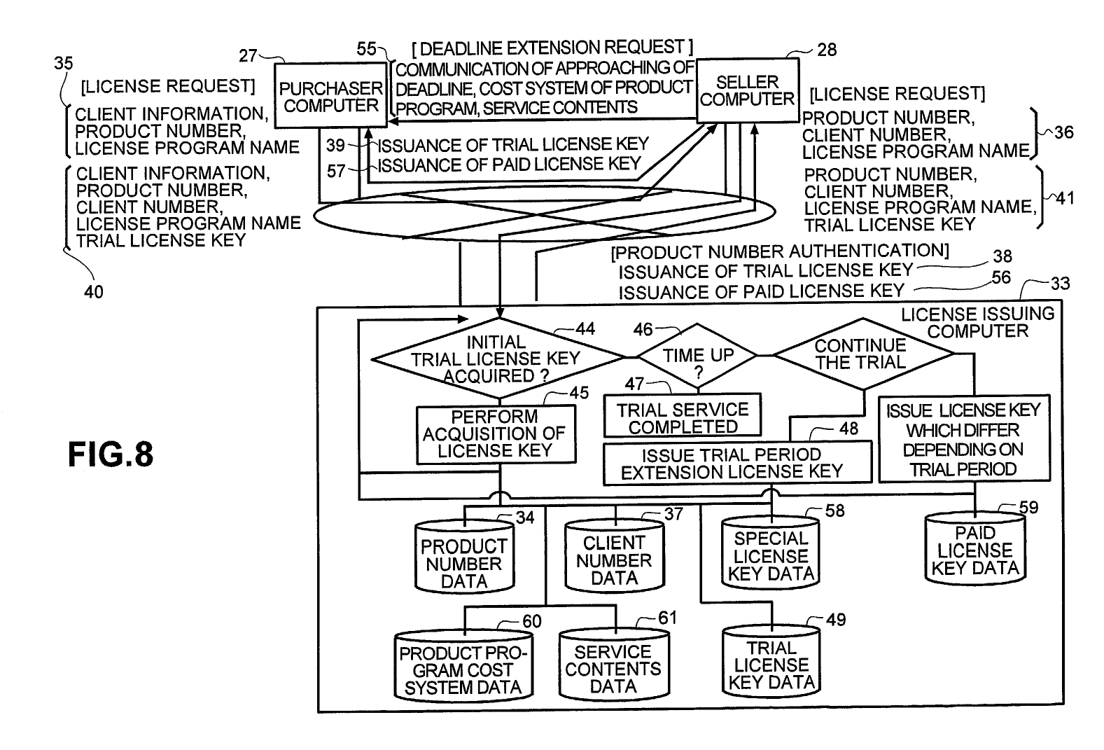

FIG. 8 is a schematic diagram of a sixth embodiment of the program license key issuing method according to the present invention. The sixth embodiment involves providing a service by which a product program can be used on a trial basis and if the deadline of the trial period is immanent and an extension of the deadline is needed, extension of the deadline of the trial period can be accomplished and information of a service in which the shorter the trial period through provision of increased disc use capacity.

In receiving a license key from a license-issuing computer connected to a network, a user transmits from purchaser computer 27 to seller computer 28 client information and a license program name (35), as well as information including a product number and a client number for identifying the purchaser, all of which are necessary for acquiring a trial license key to make product programs of a disc subsystem device operable on a trial basis.

Seller computer 28 eliminates the client information transmitted from the purchaser computer and transmits to license-issuing computer 33 the product number and a license program name (36) which are required for issuing the trial licensing key. License-issuing computer 33 contains data about product number 34 and client number 37 which have been already shipped to the client. License-issuing computer 33 locates 44 the product and client numbers transmitted from seller computer 28. When these product numbers and the client numbers are respectively compared and found to match, a trial license key 38 based on the transmitted license program name is transmitted to seller computer .28 Subsequently, seller computer 28 issues trial license key 39 to purchaser computer 27.

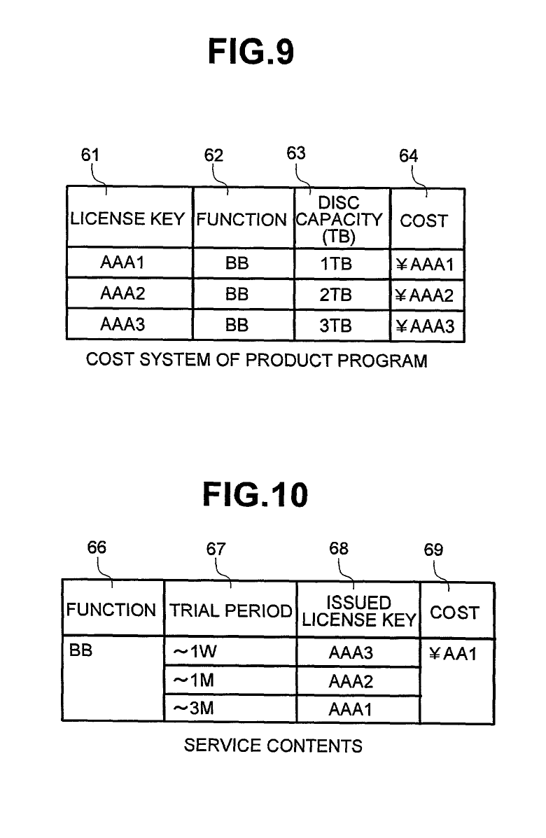

Further, when a deadline of a trial period set by trial license key 39 is near and continuation of the trial is necessary, notification that the trial will soon expire, a cost system table for the product program (FIG. 9), and service contents (FIG. 10) are transmitted to the purchaser.

The purchaser refers to the cost system table of the product program (FIG. 9) and to the service contents (FIG. 10) and decide whether to continue the trial cor to change to a paid license. FIG. 9 shows the cost system of the product program and FIG. 10 shows the service contents. Information about the cost system table of the product program (FIG. 9) are stored in information data bases (DBs) 56, 61 of license-issuing computer 33. When a purchaser continues a trial, a special license key is issued. When a purchaser wants to change from a trial license to a paid license, a paid license key is issued.

The cost system (FIG. 9) of the usual product program is comprises AAA1-AAA3 of paid license key 61. Although their functions are the same, a cost 64 is set such that it increases in proportion to the subsystem capacity 63.

On the other hand, the service contents (FIG. 10) of license-issuing computer 33 comprise information, including information 66 which identifies functions; a trial period 67; a paid license key 68; and information on cost 69.

This service issues a paid license key corresponding to the length of the trial period. As shown in FIG. 10, a license key 68 having a high capacity which is determined by numeral 63 of the subsystem capacity of FIG. 9, is issued depending on the trial period 67 at the same cost 69 of a standard license key, and this gives a great advantage to the purchaser.

The purchaser decides whether to continue the trial or to change to a paid use, based on the proposal from the seller. When the issuance of the paid license key is desired, the purchaser, using purchaser computer 27, transmits to seller computer 28 the client information, the license program name and the trial license key, as well as information including the product number and the client number for identifying the purchaser.

Seller computer 28 excludes the client information from the information transmitted by client computer 27 and transmits the product number, the license program name and the trial license key, which are necessary for issuing a paid license key, to the license-issuing computer 33.

License-issuing computer 33 contains the trial license key information which has been issued to the client. License-issuing computer 33 locates the product number and the trial license key transmitted from the seller computer. When they are compared and found to match, a paid license key based on the transmitted license program name and corresponding to the trial period 67, as shown in FIG. 10, is transmitted to seller computer 28.

Thereafter, seller computer 28 issues a paid license key to purchaser computer 27.

According to the above-mentioned embodiment, when the license key reaches a given time and is changed over to a paid license key, the trial period thereby being shortened by the client, the service which issues a license key has a high disc capacity of the disc subsystem device provided to the user. Accordingly, the possibility exists that a user who has hesitated to purchase the service in view of the cost will now use the service; hence, it is believed that this option will increase sales of the programs. If the client selects the product which he wants, this system can give rise to a new request by determining the potential needs whether the trial period is to be extended or the paid license key is to be acquired. To minimize the possibility that a service provider cannot recover fair payment for a paid license key, the license provider issues the license key having the high disc capacity for the trial period.

As has been explained, according to the present invention, when a licensor issues a license key through a seller, an agent, or the like, on line, it becomes possible to conceal business information, including the client information held by the seller/agent for comparison with information from the licensor.

Further, according to the present invention, when a SAN data storage system is augmented, even when a change is made in the configuration of a SAN, or the like, a user can readily receive online a license for an optional program which has become necessary.

Further, according to the present invention, by issuing a license key which allows the use of the program for a given period or a license key which allows the extension of the use period, the likelihood that a user will continue to use the program is increased, with the advantage that increased sales of the program can be obtained.

The preceding has been a description of the preferred embodiment of the invention. It will be appreciated that deviations and modifications can be made without departing from the scope of the invention, which is defined by the appended claims.

What is claimed is:

1. A license key issuing system comprising:
a network which connects a license-issuing computer, a seller computer and a purchaser computer,
the purchaser computer having capability to input client information, product information and license program information, the purchaser computer requesting the license-issuing computer to issue issuance of a license key by inputting the client information, the product information and the license program information;
the seller computer receiving the client information, the product information and the license program information from the purchaser computer and requesting the issuance of the license key together with the product information and the license program information, the seller computer transmitting the license key to the purchaser computer upon receiving the license key from the license-issuing computer; and
the license-issuing computer having license key issuing means, the license-issuing computer receiving the product information and the licensing program information from the seller computer and issuing a license key of a program specified by the license program information through the seller computer to the purchaser computer when the authentication of the product information is normally finished.

2. A license-issuing computer which is connected to a network and issues a license key through the network, the license-issuing computer including:
a program which allows the license-issuing computer to receive product information and license program information out of client information, the product information and the license program information which a purchaser inputs from a seller computer through a network, and
a program which performs the authentication of the product information and issues a license key of a program specified by the license program information when the authentication is normally finished.

3. A license-issuing computer which is connected to a network and performs the issuance of a license key through the network, the license-issuing computer including:
a program which allows the license-issuing computer to receive product number and license program name out of client information, the product number and the license program name which a purchaser inputs or the product number, the license program name and a trial license key out of the client information, the product number and the license program name and the trial license key which the purchaser inputs from a seller computer through the network, and
a program which performs the authentication of the product number and, when the authentication is normally finished, issues a trial license key which allows the use of a program specified by the license program name for a given time upon receiving the product number and the license program name or issues a special license key which extends the trial period by the trial license key upon receiving the product number, the license program name and the trial license key.

4. A license-issuing computer characterized in that the license-issuing computer of claim 3 issues a license for a program installed in a data storage system.

5. A license-issuing computer which is connected to a network and performs the issuance of a license key through the network, the license-issuing computer including:
a program in which the license-issuing computer receives a product number and a license program name inputted by a purchaser or the product number, the license program name and a trial license key inputted by the purchaser through the network,
a program in which the license-issuing computer performs the authentication of the product number when the product number and the license program name are received, and issues the trial license key which allows the use of a program specified for the license program name for a given period when the authentication is normally finished, and
a program in which the license-issuing computer performs the authentication of the trial license key when the license-issuing computer receives the license program name and the trial license key and has a program which issues a paid license key which exhibits a higher function as the trial period becomes shorter.

6. A seller computer which requests the issuance of a license key to a license-issuing computer in response to a request from a purchaser computer through a network, the seller computer including:
a program which requests the inputting of client information, product information and license program information to the purchaser computer through the network,
a program which receives the client information, the product information and the license program information from the purchaser computer through the network and transmits the product information and the license program information to the license-issuing computer, and
a program which receives the license key from the license-issuing computer and transmits the license key to the purchaser computer;
A seller computer which requests the issuance of a license key to a license-issuing computer in response to a request from a purchaser computer through a network, the seller computer including:
a program which requests the inputting of client information, product information and license program information to the purchaser computer through the network,
a program which receives the client information, the product information and the license program information from the purchaser computer through the network and transmits the product information and the license program information to the license-issuing computer, and
a program which receives the license key from the license-issuing computer and transmits the license key to the purchaser computer;

7. A seller computer which requests a trial license key which allows the use of a program for a given period and a special license key which extends a trial period of the trial license key to a license-issuing computer in response to a request from a purchaser computer through a network, the seller computer including:
means for inputting a product number, a license program name and a trial license key communicated from a purchaser,
means for outputting the license key received from the license-issuing computer,
a program which requests the inputting of the client information, the product number and the license program name to the purchaser computer through the network,
a program which receives the client information, the product information and the license program information from the purchaser computer through the network and transmits the product information and the license program information to the license-issuing computer or transmits the product number, the license program name and the trial license key inputted by the inputting means to the license-issuing computer, and
a program which receives the trial license key from the license-issuing computer and transmits the license key to the purchaser computer or receives the special license key from the license-issuing computer and outputting the special license key from the outputting means.

8. A data transfer method of a seller computer requesting the issuance of a license key to a license-issuing computer in response to a request from a purchaser computer through a network, the data transfer method including
a step in which the seller computer receives client information, product information and license program information from the purchaser computer,
a step in which the seller computer transmits the product information and the license program information to the license-issuing computer,
a step in which the seller computer receives a license key from the license-issuing computer, and
a step in which the seller computer transmits the license key to the purchaser computer.

9. A data transfer method of a seller computer requesting the issuance of a license key to a license-issuing computer in response to a request from a purchaser computer through a network, the data transfer method including:
a step in which the seller computer receives client information, a product number and a license program name from a purchaser computer,
a step in which the seller computer transmits the product number and the license program name to the license-issuing computer,
a step in which the seller computer receives a trial license key which allows the use of the program for a given period from the license computer,
a step in which the seller computer transmits the license key to the purchaser computer,
a step in which the seller computer inputs the client information, the product number, the license program name and the trial license key communicated from a purchaser therein,
a step in which the seller computer transmits the product number, the license program name and the trial license key to the license-issuing computer,
a step in which the seller computer receives a special license key for extending the deadline of the trial period by the trial license key from the license-issuing computer, and
a step in which the seller computer outputs the special license key and transmits the special license key to the purchaser.

10. A licensing issuing method of a license issuing system comprising a license-issuing computer, a seller computer, a purchaser computer, and a network which connects the license-issuing computer, the seller computer and the purchaser computer, wherein
the license-issuing computer requests the inputting of client information, product information and license program information to the purchaser computer through the seller computer,
the purchaser computer transfers the client information, the product information and the license program information to the seller computer in response to the request from the license-issuing computer,
the seller computer transfers the product information and the license program information out of the client information, the product information and the license program information received from the purchaser computer to the license-issuing computer, and
the license-issuing computer issues a license key for a program specified by the license program information to the purchaser computer through the seller computer when the authentication of the product information received by the seller computer is normally finished.

11. A license issuing method of a license-issuing computer which is connected to a network and performs the issuance of a license key through the network, the license issuing method including:
a step in which the license-issuing computer receives product information and license program information out of client information, the product information and the license program information which a purchaser inputs from a seller computer through the network,
a step in which the license-issuing computer performs the authentication of the product information, and
a step in which the license-issuing computer issues a license key for a program specified by the license program information when the authentication is normally finished.

12. A method as in claim 11 wherein the license-issuing computer issues a license key for a program specified by a license program name.

13. A license issuing method of a license-issuing computer which is connected to a network and performs the issuance of a license key through the network, the license issuing method including:
a step in which the license-issuing computer receives product number and a license program name out of client information, the product number and the license program name which a purchaser inputs from a seller computer through the network,
a step in which the license-issuing computer performs the authentication of the product number,
a step in which the license-issuing computer issues a trial license key which allows the use of a program specified by the license program name for a given period when the authentication is normally finished,
a step in which the license-issuing computer receives the product number, the license program name and the trial license key out of client information, the product number, the license program name and the trial license key which a purchaser inputs from the seller computer through the network,
a step in which the license-issuing computer performs the authentication of the trial license key, and
a step in which the license-issuing computer issues a special license key which extends a trial period by the trial license key when the authentication is normally finished.

14. A license issuing method characterized in that the license issuing method according to claim 13 issues the license for a program installed in a data storage system.

15. A license issuing method of a license-issuing computer which is connected to a network and performs the issuance of a license key through the network, the license issuing method including:
a step in which the license-issuing computer receives a product number and a license program name which a purchaser inputs through the network,
a step in which the license-issuing computer performs the authentication of the product number,
a step in which the license-issuing computer issues a trial license key which allows the use of a program specified by the license program name for a given period when the authentication is normally finished,
a step in which the license-issuing computer receives the product number, the license program name and the trial license key which the purchaser inputs through the network,
a step in which the license-issuing computer performs the authentication of the trial license key, and
a step in which the license-issuing computer issues a paid license key which exhibits a higher function as the trial period becomes shorter.

16. A license issuing method according to claim 15, wherein the license-issuing computer issues a license for a program installed in a data storage system.

17. A license issuing method according to claim 16, wherein the license-issuing computer issues the paid license key which has a larger usable disc capacity as the trial period becomes shorter.
